(19) United States
(12) Patent Application Publication
(10) Pub. No.: US 2018/0051582 A1
(43) Pub. Date: Feb. 22, 2018

(54) ROTATING BRUSH SLEA WITH BRISTLE SHIELD

(71) Applicant: General Electric Company, Schenectady, NY (US)

(72) Inventors: Xiaoqing Zheng, Niskayuna, NY (US); Gene David Palmer, Clifton Park, NY (US); Michael Dennis Mack, Ballston Spa, NY (US); David Bruce Knorr, Clifton Park, NY (US); Jason Lyn Bowers, Rexford, NY (US)

(73) Assignee: General Electric Company, Schenectady, NY (US)

(21) Appl. No.: 15/237,692

(22) Filed: Aug. 16, 2016

(51) Int. Cl. F01D 11/12; F01D 5/02; F01D 9/02

(52) U.S. Cl. CPC F01D 11/12; F01D 5/02; F01D 9/02; F05D 2250/232; F05D 2220/31; F05D 2240/56; F05D 2260/30; F05D 2220/32

(57) ABSTRACT

A brush seal has bristles with a free end sealing against a radially inward surface of a stationary component. The bristles are angled axially 15 degrees to 70 degrees, and circumferentially at an angle that is less than the axial angle. A retaining plate extends radially outward from the rotating component, and supports the bristles from centrifugal loading in an operative state of a turbomachine. A bristle shield extends radially outward along a length of the bristles, such that the bristle shield is configured to shield the bristles from flow during an operative state of the turbomachine. The bristles are located between the retaining plate and the bristle shield. A circumferential groove has a downstream side and an upstream side, and a side plate is attached to the upstream side. The fixed end of the bristles is attached to the upstream side of the groove by the side plate.

### BACKGROUND OF THE INVENTION

Embodiments of the invention relate generally to brush seals and, more particularly, to a rotating brush seal attached to a rotating component wherein the bristles of the brush seal protected by a bristle shield, more than circumferentially.

Known brush seals are typically mounted or attached to a stationary component of a turbomachine, where only the flexible bristle tips of the brush seal engage a rotating component during operation of the turbomachine to form a dynamic seal. Known brush seals also typically include bristles that are angled circumferentially with respect to the rotating component.

### BRIEF DESCRIPTION OF THE INVENTION

In one aspect, a brush seal for use between a rotating component and a stationary component in a turbomachine is provided. The brush seal includes a set of flexible bristles having a fixed end and a free end. The free end of the set of flexible bristles seals against a radially inward surface of the stationary component. The set of flexible bristles are angled axially at an axial angle of about 15 degrees to about 70 degrees with respect to the rotating component. The set of flexible bristles are also angled circumferentially at an angle that is less than the axial angle. A frusto-conical retaining plate extends radially outward from the rotating component at least partially along a length of the set of flexible bristles, such that the retaining plate is configured to at least partially support the set of flexible bristles on a radially inner surface of the retaining plate from centrifugal loading in an operative state of the turbomachine. A bristle shield extends radially outward from the rotating component at least partially along a length of the set of flexible bristles, such that the bristle shield is configured to at least partially shield the set of flexible bristles from flow during an operative state of the turbomachine. The set of flexible bristles is located between the retaining plate and the bristle shield. A circumferential groove is in the rotating component, and the circumferential groove has a downstream side and an upstream side. A side plate is attached to the upstream side of the circumferential groove. The fixed end of the set of flexible bristles is attached to the upstream side of the circumferential groove by the side plate, and the retaining plate is attached to both the downstream and upstream side of the circumferential groove. The retaining plate is attached to the upstream side of the circumferential groove by the side plate in the rotating component.

In another aspect, a turbomachine includes a rotating component having a circumferential groove therein. The circumferential groove has an upstream side and a downstream side. A side plate is attached to the circumferential groove. The turbomachine also includes a stationary component and a brush seal for use between the rotating component and the stationary component. The brush seal includes a set of flexible bristles having a fixed end and a free end. The fixed end of the set of flexible bristles is attached to the circumferential groove by the side plate. The free end of the set of flexible bristles seals against a radially inward surface of the stationary component. The set of flexible bristles are angled axially at an axial angle of about 15 degrees to about 70 degrees with respect to the rotating component. A retaining plate extends at least partially along a length of the set of flexible bristles, such that the retaining plate is configured to at least partially support the set of flexible bristles from centrifugal loading in an operative state of the turbomachine. The retaining plate is attached to the circumferential groove in the rotating component. A bristle shield extends radially outward from the rotating component at least partially along a length of the set of flexible bristles, such that the bristle shield is configured to at least partially shield the set of flexible bristles from flow during an operative state of the turbomachine. The set of flexible bristles are located between the retaining plate and the bristle shield.

In yet another aspect, a brush seal is provided for use between a rotating component and a stationary component in a turbomachine. A circumferential groove is in the rotating component, and a side plate is attached to the circumferential groove. The brush seal includes a set of flexible bristles having a fixed end and a free end. The fixed end of the set of flexible bristles is attached to the circumferential groove by the side plate. The free end of the set of flexible bristles seals against a radially inward surface of the stationary component. The set of flexible bristles are axially angled at an angle of about 15 degrees to about 70 degrees with respect to the rotating component. The set of flexible bristles are circumferentially angled at an angle that is less than the axial angle. A retaining plate is attached to the circumferential groove by a dovetail assembly. The retaining plate extends radially outward from the rotating component at least partially along a length of the set of flexible bristles, such that the retaining plate is configured to at least partially support the set of flexible bristles on a radially inner surface of the retaining plate from centrifugal loading in an operative state of the turbomachine. A bristle shield extends radially outward from the rotating component at least partially along a length of the set of flexible bristles, such that the bristle shield is configured to at least partially shield the set of flexible bristles from flow during an operative state of the turbomachine. The set of flexible bristles are located between the retaining plate and the bristle shield.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a partial cross-sectional view of a turbomachine including a brush seal as known in the art.

FIGS. 2 and 3 show cross-sectional views of a brush seal as known in the art.

FIGS. 4-8 show cross-sectional views of brush seals according to aspects of this invention.

FIG. 9 shows an axial cross-sectional view of a portion of a brush seal according to an aspect of this invention.

FIGS. 10-12 show exploded views of gaps between arcuate segments of a brush seal according to aspects of this invention.

FIGS. 13-14 illustrate top, cross-sectional views of the flexible bristles and the bristle shield, according to aspects of this invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

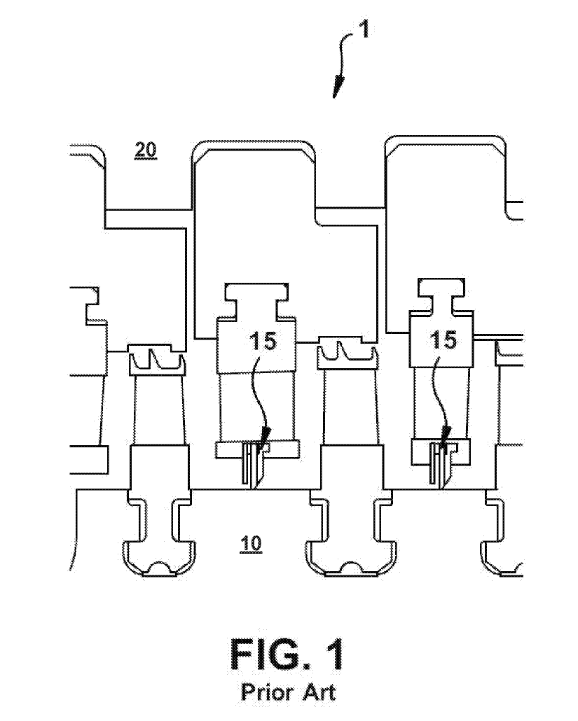

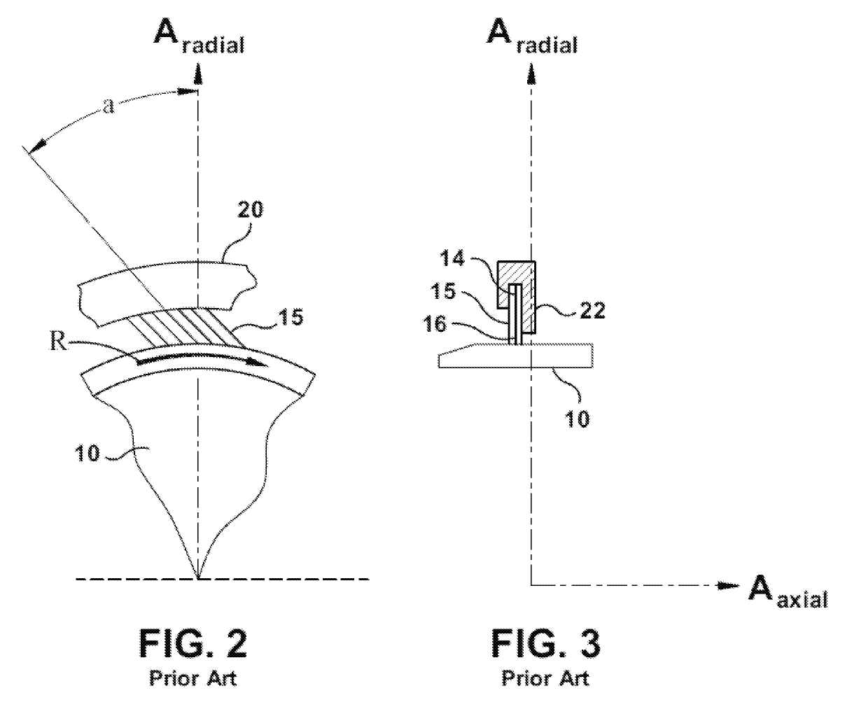

Turning now to the drawings, FIG. 1 shows a cross-sectional view of a conventional brush seal 15, as known in the art, in use in a turbomachine 1. Two additional views of brush seal 15 are shown in FIGS. 2 and 3. As illustrated in FIGS. 2 and 3, brush seal 15 comprises a set of bristles for use between a rotating component 10 (also referred to as a rotor) and a stationary component 20 of turbomachine 1 (e.g., a gas turbine, steam turbine, etc.). It is understood that brush seal 15 forms a ring when installed in turbomachine 1, and typically brush seal 15 comprises a series of arcuate segments forming the complete ring when installed. As known in the art, brush seal 15 has a fixed end 14 mounted or attached to stationary component 20, and a flexible free end 16 that extends towards rotating component 10 to form a dynamic seal. A backing plate 22 can also be included (mounted on stationary component 10), that acts to support flexible free end 16 as it is pressed against backing plate 22 by pressure loading while turbomachine 1 is in an operative state. As shown by arrow R in FIG. 2, in an operative state, rotating component 10 rotates in the direction of arrow, R. As shown in FIGS. 2 and 3, the bristles of brush seal 15 are angled circumferentially with respect to an axial axis, Aₐₓᵢₐₗ, and a radial axis, A_{radial}, of rotating component 10. The angled bristles are easy to deflect and will move radially as rotating component 10 undergoes excursion or vibration.

As illustrated by angle, a, in FIG. 2, the bristles of brush seal 15 are angled circumferentially with respect to the axial and radial axes (Aₐₓᵢₐₗ and A_{radial}, shown in FIGS. 2 and 3) of rotating component 10. Since the bristles are angled along the same circumferential direction as rotational direction, R, of rotating component 10, the bristle tips can ride on the surface of rotating component 10 without causing buckling or locking up. The circumferential angle, a, of the bristles, also called the “cant angle” or “lay angle,” is orientated such that free end 16 extends in the same direction as rotational direction, R, of rotating component 10.

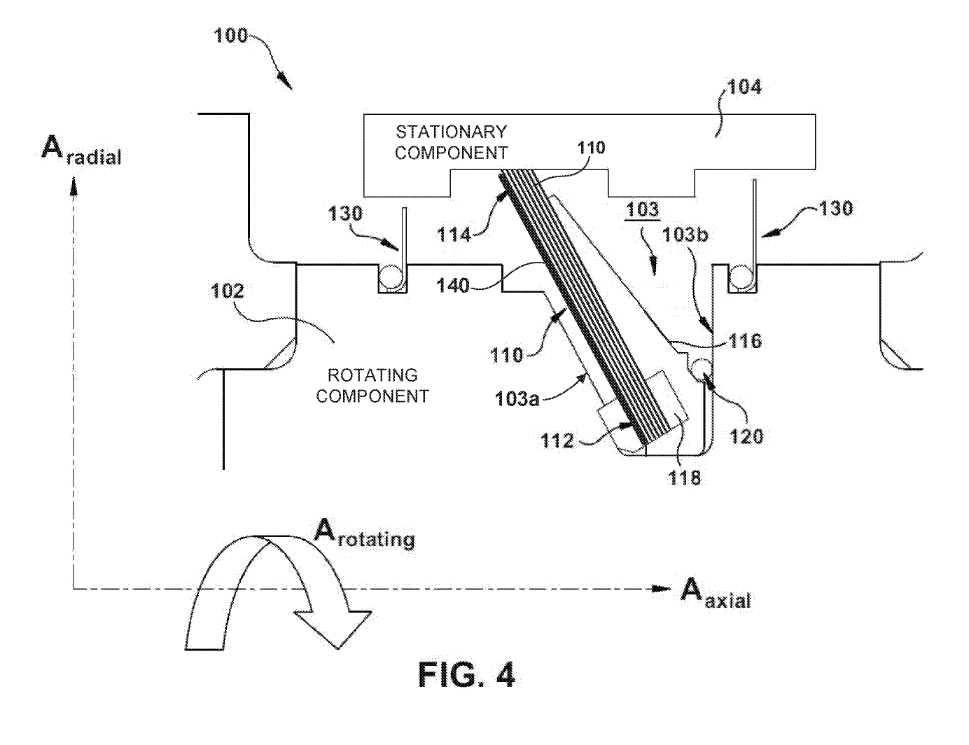

FIG. 4 illustrates a cross-sectional view of a brush seal 100 according to aspects of this invention. Brush seal 100 is used to form a dynamic seal between a rotating component 102 and a stationary component 104 in turbomachine 1 (FIG. 1). Brush seal 100 comprises a set of bristles 110 and forms a ring when installed. For example, brush seal 100 can comprise a series of arcuate segments forming a complete ring when installed. In addition, the set of bristles 110 has a fixed end 112 and a free end 114. However, brush seal 100 differs from known seals in the art in several aspects. For example, as discussed in more detail herein, fixed end 112 is mounted, or attached, to rotating component 102, not stationary component 104. Also, the set of bristles 110 is angled substantially axially, not mainly circumferentially (as in known systems), with respect to rotating axis, A_{rotating}, of rotating component 102. A bristle shield 140 is placed adjacent to the bristles 110, and the bristle shield 140 both protects and shields the bristles from flow during an operative state of the turbomachine.

As shown in FIG. 4, brush seal 100 further includes a conical or frusto-conical retaining plate 116 that at least partially supports, i.e., bears a partial load of, the set of bristles 110. Frusto-conical retaining plate 116 extends at least partially along a radial length of the set of bristles 110 such that, in an operative state of the turbomachine, retaining plate 116 at least partially supports the set of bristles 110 from centrifugal loading.

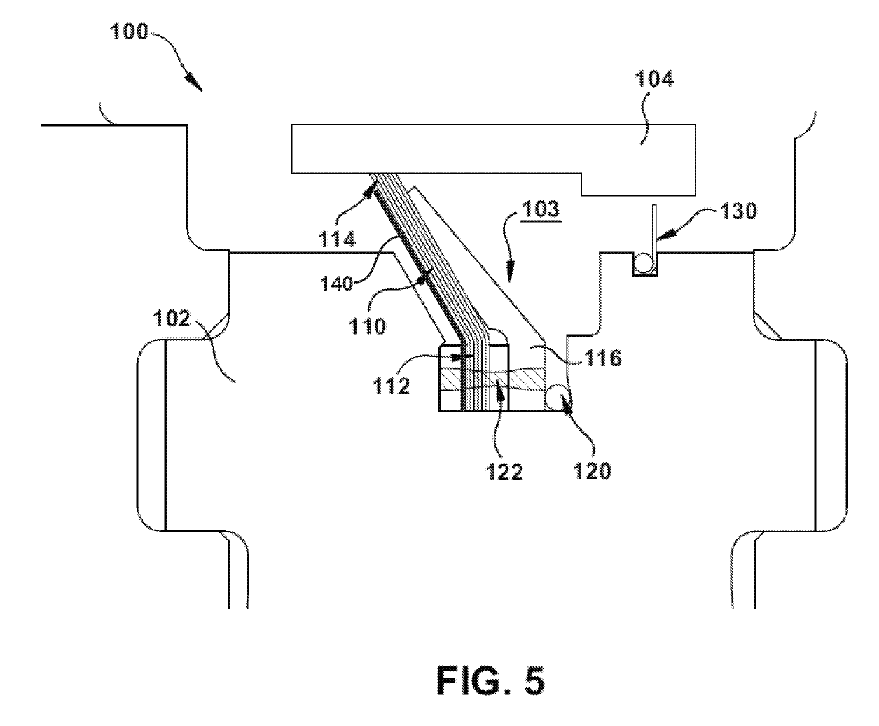

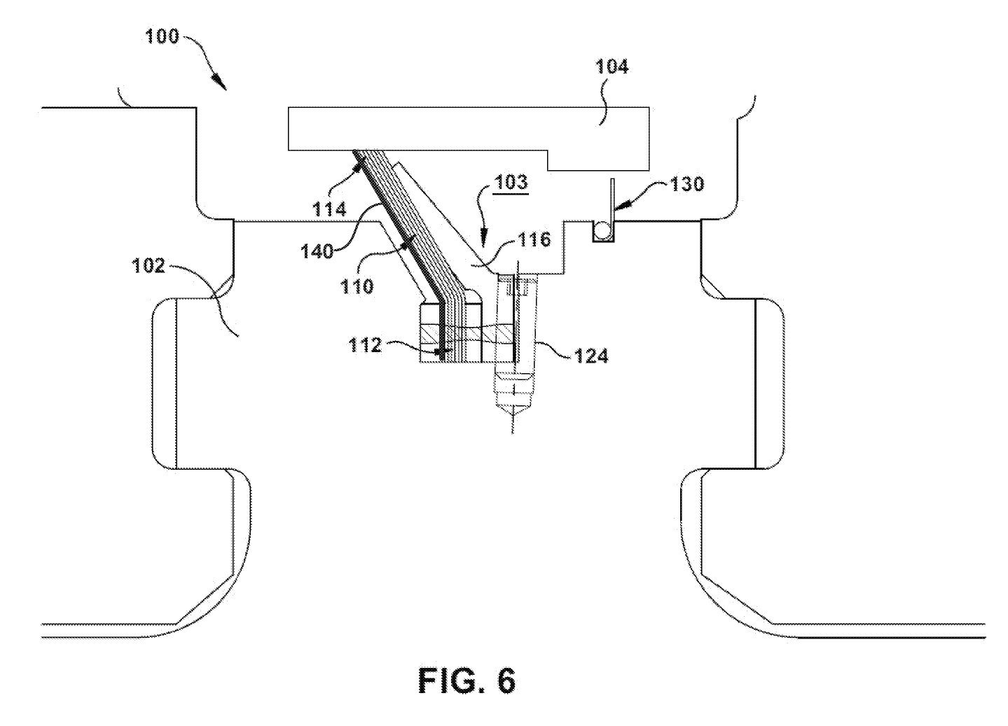

The bristles 110 are sandwiched between the retaining plate 116 and the bristle shield 140. As shown in FIG. 4, the bristle shield 140 extends radially outward from the rotating component and at least partially along a length of the set of flexible bristles 110. The bristle shield 140 extends radially outward or past the retaining plate 116, as shown in FIG. 4. However, the bristle shield may extend all the way to the radially inward surface of the stationary component 104 (as shown in FIG. 6), or to about the same outer radial distance as the retaining plate 116 (as shown in FIG. 5). The amount of shielding and protection provided by the bristle shield 140 may be adjusted by the “height” of the bristle shield. Higher bristle shields may be desired in applications where bristle protection is a priority, whereas lower bristle shields may be more desirable where larger rotational clearances between the rotating and stationary components are specified.

The bristle shield 140 may be comprised of a second set of thicker and stiffer bristles than the bristles in flexible bristles 110. As one example only, the flexible bristles 110 may be comprised of bristles having a diameter of about 2.5 mils to about 4 mils. The bristles in the bristle shield 140 may have a diameter of about 5 mils to about 10 mils, so it can be seen that the bristles in bristle shield 140 are thicker and stiffer than the bristles in flexible bristles 110. The thinner bristles 110 are better at sealing, but are more susceptible to damage or deformation from flow or flow disturbances. The thicker bristles in bristle shield 140 are less effective at sealing, but are better at resisting damage from flow. The combination of thick/thin bristles as described results in a more robust and better sealing brush seal.

As referenced above, embodiments of this invention include a brush seal 100 having a fixed end 112 mounted, or attached to, rotating component 102. FIGS. 4-8 show various examples of how fixed end 112 of bristles 110 can be mounted or attached to rotating component 102. As shown in FIGS. 4-8, a circumferential groove 103 can be included in rotating component 102. Circumferential groove 103 has a first, front, side 103a and a second, back, side 103b (FIG. 4). Frusto-conical retaining plate 116 and fixed end 112 of the set of bristles 110 can be inserted into groove 103, and attached to rotating component 102 as desired. In a first example, shown in FIG. 4, retaining plate 116 can be attached to back (or downstream side) side 103b through the use of caulks and/or welds. Caulk 120 and/or welds along faces of retaining plate 116 contact groove 103, and fixed end 112 can be attached to front (or upstream) side 103a and retaining plate 116 through the use of a side plate 118. It is also understood that brazed or soldered joints can be used in conjunction with, or in place of, the caulk and welded joints discussed herein.

In a second example, shown in FIG. 5, the set of bristles 110 is bent such that fixed end 112 is axially displaced with respect to free end 114. Therefore, retaining plate 116 is similarly bent, such that retaining plate 116 extends along at least a portion of the length of the set of bristles 110. Again, as in FIG. 4, retaining plate 116 and the set of bristles 110 can be attached to groove 103 through the use of caulks and welds. An electron beam weld 122, shown in FIG. 5, is another example of how the set of bristles 110 may be attached to retaining plate 116. The bristle shield 140 extends radially outward to about the same radial distance as the retaining plate 116. Even in this configuration, the bristle shield 140 still shields and protects a majority of the bristles 110.

In FIG. 6, the set of bristles 110 is bent as in FIG. 5, but in this example, a screw 124 (e.g., a grub screw) is used to attach retaining plate 116 to rotating component 102. Screw 124 can be screwed through retaining plate 116 into rotating component 102, in addition to, or in place of, the caulk/friction combination that is used in FIGS. 4 and 5. It is also understood that other fasteners, other than a screw, can be used, for example, a bolt, a pin, etc. The bristle shield 140 has an end that is adjacent to the radially inward surface of the stationary component 104. This configuration will provide maximum shielding and protection for the bristles 110, and may be desirable in applications were clearances are minimal.

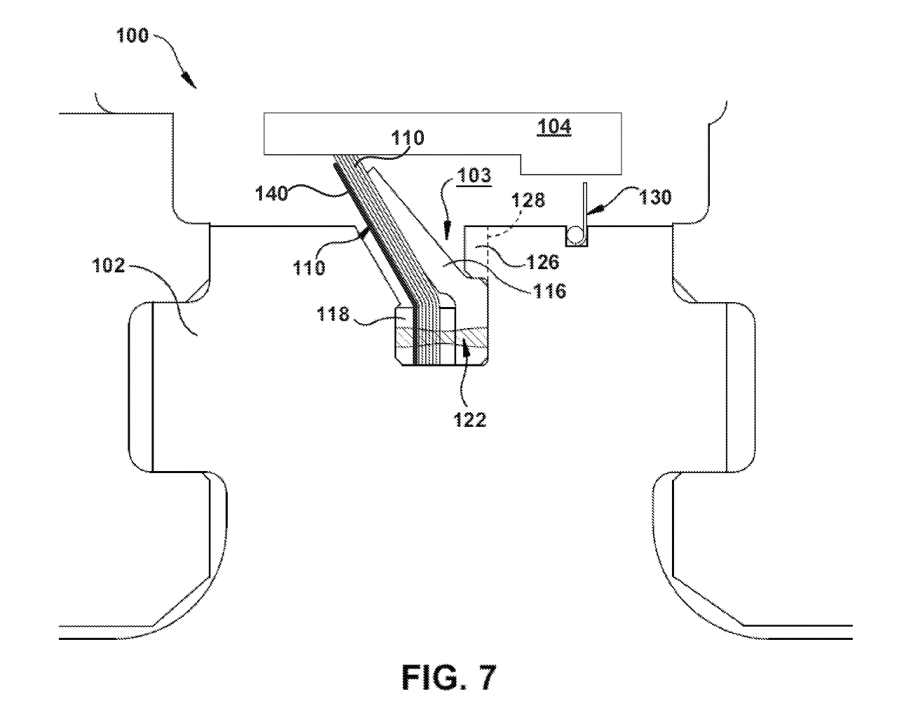

As shown in FIG. 7, a dovetail assembly can be used to attach retaining plate 116, bristle shield 140 and the set of bristles 110 to rotating component 102. In this example, groove 103 includes a retaining feature 126 which holds retaining plate 116 (which is attached to the set of bristles 110 through the use of a weld 122 and side plate 118 in this example) in place once the set of bristles 110 is slid circumferentially into groove 103. In order to facilitate sliding the set of bristles 110 into groove 103, an entry dovetail slot 128 can be used (illustrated by dotted line in FIG. 7). The bristle shield 140 extends radially outward of the end of the retaining plate 116, and a substantial majority of the bristles 110 are shielded and protected by bristle shield 140.

In any of the embodiments discussed herein, retaining plate 116 can be integrally machined into rotating component 102 or can comprise a separate element that is welded or otherwise attached to rotating component 102. If retaining plate 116 is integral to rotating component 102, as discussed herein, an entry groove/slot (similar to slot 128 shown in FIG. 7) can be used to insert the set of bristles 110 and bristle shield 140 into rotating component 102. In this embodiment, a relatively small entry slot 128 can be used, and this embodiment could result in a relatively more compliant brush seal 100 because the set of bristles 110 and bristle shield 140 could be bent as they are fed into the groove/slot. Bending the set of bristles 110 and bristle shield 140 in this way could result in less gap leakages between the segments of brush seal 100, as well as minimize the issues of holding the set of bristles 110 in the area of the entry slot. This embodiment would further reduce the total rotating mass of brush seal 100 as an additional back plate would not be necessary.

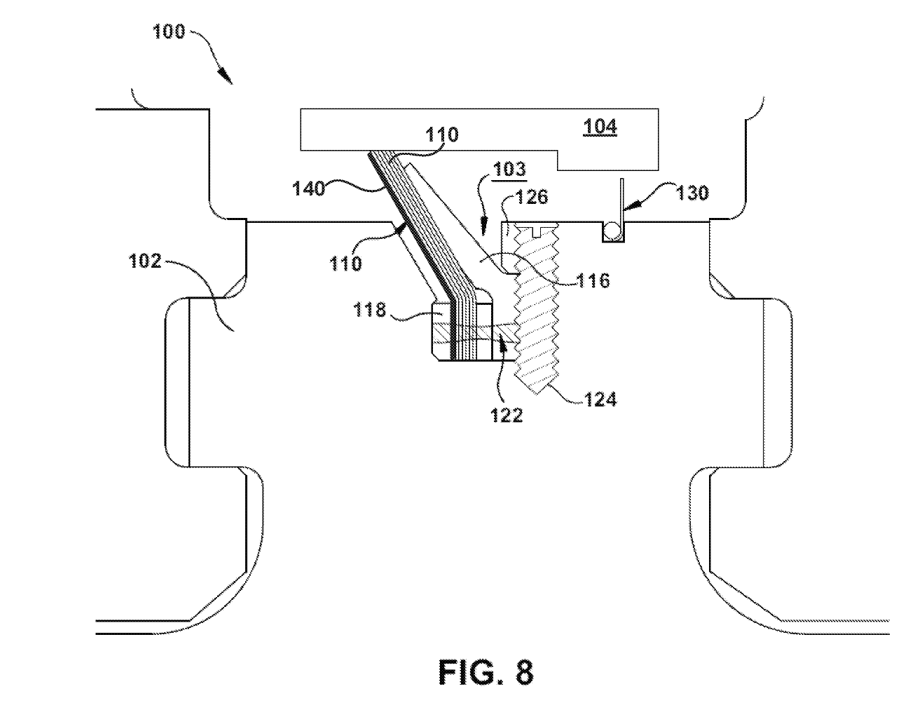

In FIG. 8, a modification of the configurations shown in FIGS. 6 and 7 is shown. In this embodiment, a retaining feature 126 (similar to FIG. 7) can be used along with a pin or grub screw 124 (similar to FIG. 6), where one or more pins 124 can act as anti-rotation mechanisms for brush seal 100 elements. A variety of configurations for pins 124 are possible (and applicable to any embodiments shown herein including pins 124). For example, (1) one anti-rotation pin 124 per segment can be used, with pins 124 either at a middle section of a segment, or just inboard of the end of the segment to limit segment movement which could lead to imbalance, (2) one anti-rotation pin 124 can be used, positioned on each side of the entry slot 128 (FIG. 7), or (3) one anti-rotation pin 124 can be used, positioned between the two adjacent segment ends, and centered in the middle of entry slot 128 (FIG. 7). The bristle shield 140 extends close to, but does not touch, the radially inward surface of the stationary component.

Regardless of how brush seal 100 is mounted to rotating component 102, the axial angle of the set of bristles 110 and/or bristle shield 140 of brush seal 100 assists in allowing brush seal 100 to seal effectively. Since brush seal 100 rotates with rotating component 102, if the set of bristles 110 were angled substantially circumferentially, the centrifugal loading would tend to straighten the bristles out and cause bending stress at the root of the bristles. In addition, if the set of bristles 110 are allowed to straighten out, the bristles will not move inward easily, and can buckle or be damaged when brush seal 100 moves toward stationary component 104 during rotor excursion or vibration. Therefore, a large cant angle is not desirable for rotating brush seal 100 according to embodiments of this invention.

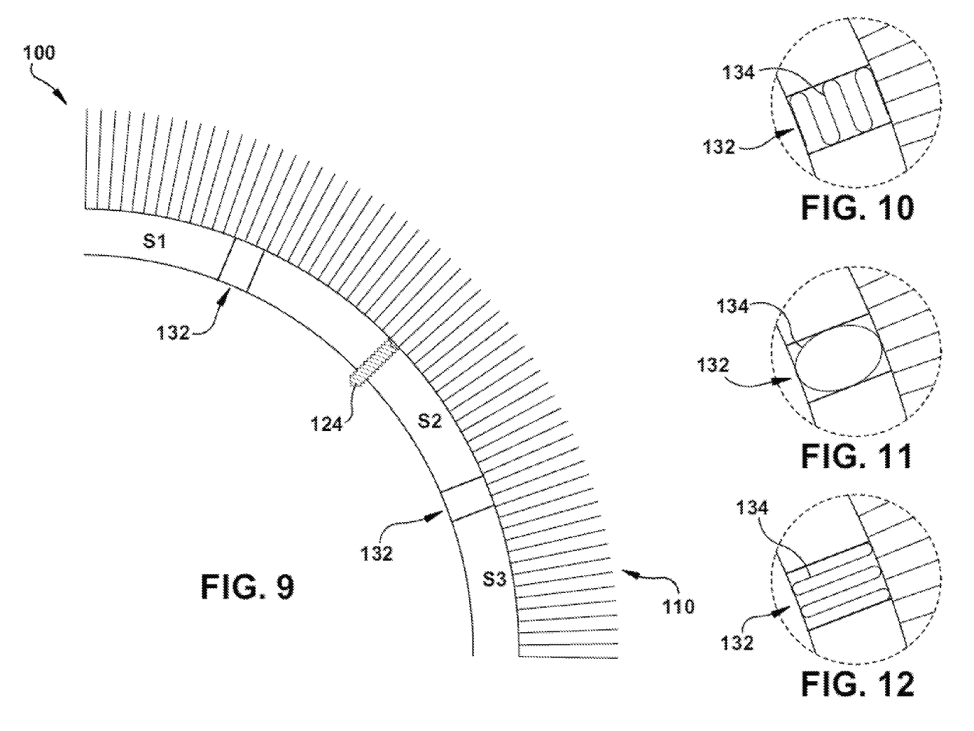

Therefore, as discussed herein, the set of bristles 110 is not angled substantially circumferentially as in prior art brush seals, but rather is mainly angled axially, and is supported by retaining plate 116 and shielded/protected by bristle shield 140. This is further illustrated in FIG. 9, showing a partial axial cross-sectional view of brush seal 100, showing the set of bristles 110 are not substantially circumferentially angled. When the turbomachine is in an operative state, the set of bristles 110 is pressed against retaining plate 116 by centrifugal force. Angling the set of bristles 110 axially, in accordance with embodiments of this invention, will cause the bristles to bend forward and away from retaining plate 116 if seal 100 is pushed by stationary component 104.

As also shown in FIG. 9, brush seal 100 can comprise a series of arcuate segments (three segments S1, S2, S3 are partially shown in FIG. 9, but it is understood that in practice, brush seal 100 can comprise a plurality of arcuate segments that will form a complete ring.) As shown in FIG. 9, gaps 132 are typically included between segments, referred to as butt gaps 132. As shown in FIG. 9, a spring 134 can be inserted in one or more butt gaps 132. Springs 134 can act to allow for thermal expansion due to brush seal 100 heating faster than rotating component 102 on startup as well as to account for different coefficients of thermal expansion between rotating component 102 and brush seal 100. Springs 134 also act to keep pressure on the segments to damp aeromechanical vibration. Springs 134 can comprise thin and stiff springs, such as wave springs, of any shape desired. Three examples of different shapes and configurations of springs 134 are shown in the exploded views of gaps 132 in FIGS. 10-12. FIG. 9 further shows an anti-rotation grub screw 124 (as discussed in connection with FIG. 8), with grub screw 124 position in the middle of segment S2.

In one embodiment of the invention, the pressure loading is from left to right referring to FIGS. 4-8, with the bristle shield 140 facing a higher pressure side of the brush seal, while retaining plate 116 is exposed to a downstream side of the brush seal with lower pressure. In such an arrangement, both the pressure force and centrifugal force act to press the set of bristles 110 against retaining plate 116 and balance the pressure loading. In another embodiment of the invention, the pressure loading can be from right to left (or vice versa, depending on the orientation of the turbomachine), where the retaining plate 116 is exposed to the higher pressure side, and the bristle shield 140 faces the lower pressure side.

The axial angle of the set of bristles 110 can be set to achieve desired flexibility without requiring excessive axial space. In one embodiment, the set of bristles 110 can be angled in an axial direction with respect to rotating component 102 at an axial angle of approximately 15 degrees to approximately 70 degrees, for example, at approximately 30 to 45 degrees.

As discussed herein, a circumferential angle of the set of bristles 110 is not necessary to make brush seal 100 flexible. However, a small circumferential angle, substantially less than the axial angle, may be beneficial for seal 100, not for flexibility reasons, but for operability, for example, in the range of approximately 0 to 15 degrees. Therefore, a small cant angle in a circumferential direction can be used, where the set of bristles 110 will contract owing to the cant angle, opening up clearance between seal 100 and stationary component 104 at no or low speed to avoid rub during transient. As speed goes up to operating condition, the set of bristles 110 will stretch out, reducing the cant angle, thus closing up the gap between the tips of the set of bristles 110 and stationary component 104.

An additional benefit of brush seal 100 according to embodiments of this invention is that the heat generated by brush seal 100 will not cause rotor bowing like conventional brush seals because the bristle tips slide on stationary component 104. The heat generated by the rubbing of the tips of the set of bristles 110 on stationary component 104 will partly go into stationary component 104 and partly be taken away by leakage through the set of bristles 110. Therefore, there is little to no heat going into rotating component 102. In contrast, in conventional brush seals, the bristle tips rub the surface of the rotating component, which heats up the rotating component directly. This heating of the rotating component can cause the rotating component to bow and further increase undesirable non-uniform heating.

As shown in FIGS. 4-8, additional seals can also be used in conjunction with brush seal 100. For example, one or more tooth seals, such as J-strip seals 130, can be used. J-strip seals 130 can have a fixed end attached to rotating component 102 and a free end extending radially outward from rotating component 102 toward stationary component 104. J-strip seals 130 can be positioned axially upstream and/or downstream of brush seal 100.

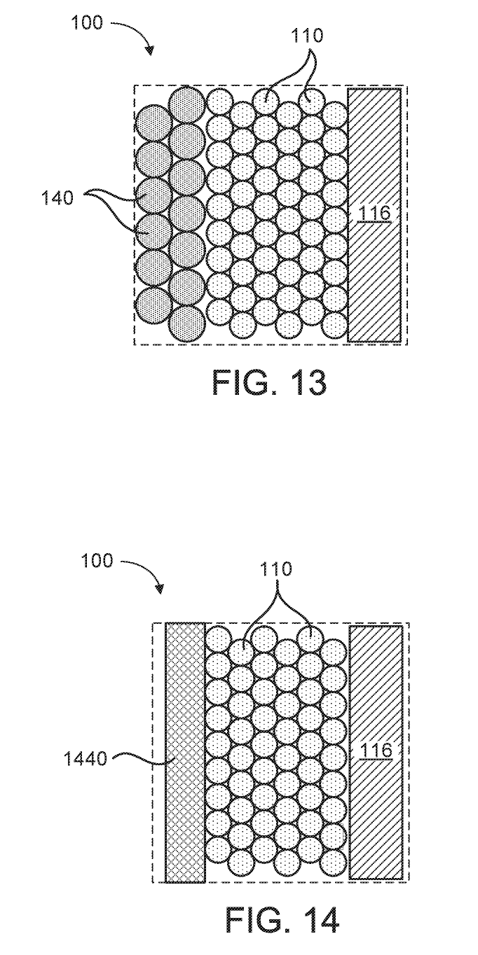

FIG. 13 illustrates a top, cross-sectional view of brush seal 100, according to an aspect of the present invention. The bristle shield 140 is comprised of a second set of thicker and stiffer bristles than the bristles in flexible bristles 110. As one example only, the flexible bristles 110 may be comprised of bristles having a diameter of about 2.5 mils to about 4 mils. The bristles in the bristle shield 140 have a thicker diameter of about 5 mils to about 10 mils. The thicker and stiffer bristles 140 protect and shield the thinner and more flexible bristles 110. Thinner bristles are better at sealing, but are more susceptible to damage or deformation from flow or flow disturbances. Thicker bristles are less effective at sealing (compared to thinner bristles), but are better at resisting damage from flow. The present combination of thick/thin bristles results in a more robust and better sealing brush seal. Both of the bristles in layers 110 and 140 may be comprised of cobalt alloys, Haynes 25, Haynes 188, or any other suitable material as desired in the specific application.

FIG. 14 illustrates a top, cross-sectional view of brush seal 100, according to an aspect of the present invention. The bristle shield 1440 is comprised of sheet metal. The sheet metal may have a thickness of about 5 mils to about 10 mils, or more, and may also be made of cobalt alloys, Haynes 25, Haynes 188, or any other suitable material. The solid nature of the sheet metal provides excellent shielding and protection of flexible bristles 110, as there are “no gaps” when compared to a bristle layer or bristle layers. However, sheet metal layer 1440 still retains flexibility and can bend radially inward if it contacts the radially inward surface of the stationary component. It most applications the radially outward edge of the sheet metal layer 1440 will be designed so it does not contact the stationary component, but still provides shielding and protection for bristles 110.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A brush seal for use between a rotating component and a stationary component in a turbomachine, the brush seal comprising:
a set of flexible bristles having a fixed end and a free end, the free end of the set of flexible bristles sealing against a radially inward surface of the stationary component, the set of flexible bristles angled axially at an axial angle of about 15 degrees to about 70 degrees with respect to the rotating component, the set of flexible bristles angled circumferentially at an angle that is less than the axial angle,
a frusto-conical retaining plate, the retaining plate extending radially outward from the rotating component at least partially along a length of the set of flexible bristles, such that the retaining plate is configured to at least partially support the set of flexible bristles on a radially inner surface of the retaining plate from centrifugal loading in an operative state of the turbomachine,
a bristle shield, the bristle shield extending radially outward from the rotating component at least partially along a length of the set of flexible bristles, such that the bristle shield is configured to at least partially shield the set of flexible bristles from flow during an operative state of the turbomachine, the set of flexible bristles located between the retaining plate and the bristle shield,
a circumferential groove in the rotating component, the circumferential groove having a downstream side and an upstream side,
a side plate attached to the upstream side of the circumferential groove, and
wherein the fixed end of the set of flexible bristles is attached to the upstream side of the circumferential groove by the side plate and the retaining plate is attached to both the downstream and upstream side of the circumferential groove, the retaining plate being attached to the upstream side of the circumferential groove by the side plate in the rotating component.

2. The brush seal of claim 1, wherein the axial angle is about 30 degrees to about 45 degrees.

3. The brush seal of claim 1, the bristle shield extending radially outward of the retaining plate, or adjacent to the radially inward surface of the stationary component, or about the same radial distance as the retaining plate.

4. The brush seal of claim 1, wherein the set of flexible bristles is bent, and an axial position at which the fixed end of the set of flexible bristles is attached to the circumferential groove is axially displaced with respect to an axial position at which the free end of the set of flexible bristles seals against the radially inward surface of the stationary component.

5. The brush seal of claim 1, wherein the conical retaining plate is retained within the circumferential groove by a dovetail assembly, the dovetail assembly comprising:
a retaining feature disposed on a radially outer portion of the circumferential groove, and
an entry dovetail slot for inserting the set of flexible bristles into the circumferential groove.

6. The brush seal of claim 1, the bristle shield comprising:
a second set of bristles that are stiffer and larger in diameter than the set of flexible bristles, or
one or more sheet metal members.

7. The brush seal of claim 1, the set of flexible bristles comprised of bristles having a diameter of about 2.5 mils to about 4 mils in diameter, and the bristle shield comprising bristles of about 5 mils to about 10 mils in diameter or sheet metal having a thickness of about 5 mils to about 10 mils.

8. A turbomachine comprising:
a rotating component having a circumferential groove therein, the circumferential groove having an upstream side and a downstream side;
a side plate attached to the circumferential groove,
a stationary component; and
a brush seal for use between the rotating component and the stationary component, the brush seal comprising:
a set of flexible bristles having a fixed end and a free end, the fixed end of the set of flexible bristles is attached to the circumferential groove by the side plate, the free end of the set of flexible bristles seals against a radially inward surface of the stationary component, the set of flexible bristles are angled axially at an axial angle of about 15 degrees to about 70 degrees with respect to the rotating component,
a retaining plate extending at least partially along a length of the set of flexible bristles, such that the retaining plate is configured to at least partially support the set of flexible bristles from centrifugal loading in an operative state of the turbomachine, the retaining plate is attached to the circumferential groove in the rotating component,
a bristle shield, the bristle shield extending radially outward from the rotating component at least partially along a length of the set of flexible bristles, such that the bristle shield is configured to at least partially shield the set of flexible bristles from flow during an operative state of the turbomachine, the set of flexible bristles located between the retaining plate and the bristle shield.

9. The turbomachine of claim 8, wherein the flexible bristles are angled circumferentially at an angle less than the axial angle.

10. The turbomachine of claim 9, the bristle shield comprising:
a second set of bristles that are stiffer and larger in diameter than the set of flexible bristles, or
one or more sheet metal members.

11. The turbomachine of claim 10, the set of flexible bristles comprising:
bristles having a diameter of about 2.5 mils to about 4 mils in diameter, and
the bristle shield comprising bristles of about 5 mils to about 10 mils in diameter, or sheet metal having a thickness of about 5 mils to about 10 mils.

12. The turbomachine of claim 11, the bristle shield extending radially outward of the retaining plate.

13. The turbomachine of claim 12, wherein the bristle shield faces a high-pressure side of the brush seal, and the retaining plate is exposed to a downstream, low-pressure side of the brush seal.

14. The turbomachine of claim 13, wherein the set of flexible bristles is bent, and an axial position at which the fixed end of the set of flexible bristles is attached to the circumferential groove is axially displaced with respect to an axial position at which the free end of the set of flexible bristles seals against the radially inward surface of the stationary component.

15. The turbomachine of claim 8, wherein the brush seal further comprises a series of arcuate segments collectively forming a ring disposed about a circumference of the rotating component within the circumferential groove.

16. A brush seal for use between a rotating component and a stationary component in a turbomachine, a circumferential groove is in the rotating component and a side plate is attached to the circumferential groove, the brush seal comprising:
a set of flexible bristles having a fixed end and a free end, the fixed end of the set of flexible bristles is attached to the circumferential groove by the side plate, and the free end of the set of flexible bristles seals against a radially inward surface of the stationary component, the set of flexible bristles are axially angled at an angle of about 15 degrees to about 70 degrees with respect to the rotating component, and the set of flexible bristles are circumferentially angled at an angle that is less than the axial angle,
a retaining plate attached to the circumferential groove by a dovetail assembly, the retaining plate extends radially outward from the rotating component at least partially along a length of the set of flexible bristles, such that the retaining plate is configured to at least partially support the set of flexible bristles on a radially inner surface of the retaining plate from centrifugal loading in an operative state of the turbomachine,
a bristle shield, the bristle shield extending radially outward from the rotating component at least partially along a length of the set of flexible bristles, such that the bristle shield is configured to at least partially shield the set of flexible bristles from flow during an operative state of the turbomachine, the set of flexible bristles located between the retaining plate and the bristle shield.

17. The brush seal of claim 16, wherein the set of flexible bristles is bent, and an axial position at which the fixed end of the set of flexible bristles is attached to the circumferential groove is axially displaced with respect to an axial position at which the free end of the set of flexible bristles seals against the radially inward surface of the stationary component.

18. The turbomachine of claim 16, the bristle shield comprising:
a second set of bristles that are stiffer and larger in diameter than the set of flexible bristles, or
one or more sheet metal members.

19. The brush seal of claim 18, the set of flexible bristles comprising:
bristles having a diameter of about 2.5 mils to about 4 mils in diameter, and
the bristle shield comprising bristles of about 5 mils to about 10 mils in diameter, or sheet metal having a thickness of about 5 mils to about 10 mils.

20. The brush seal of claim 16, the bristle shield extending radially outward of the retaining plate, or adjacent to the radially inward surface of the stationary component, or about the same radial distance as the retaining plate.
